(19) United States
(12) Patent Application Publication
(10) Pub. No.: US 2025/0158182 A1
(43) Pub. Date: May 15, 2025

(54) POWER STORAGE DEVICE

(71) Applicants: Prime Planet Energy & Solutions, Inc., Tokyo (JP); TOYOTA JIDOSHA KABUSHIKI KAISHA, Aichi-ken (JP); TOYOTA BATTERY CO., LTD., Shizuoka-ken (JP)

(72) Inventors: Yuki SATO, Toyota-shi (JP); Yozo UCHIDA, Toyota-shi (JP); Satoshi FUJIMURA, Toki-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/937,027

(22) Filed: Nov. 5, 2024

(30) Foreign Application Priority Data
Nov. 9, 2023 (JP) 2023-191761

(51) Int. Cl. H01M 50/186; H01M 50/103; H01M 50/176; H01M 50/193; H01M 50/55; H01M 50/557

(52) U.S. Cl. CPC H01M 50/186; H01M 50/103; H01M 50/176; H01M 50/193; H01M 50/55; H01M 50/557

(57) ABSTRACT

A power storage device includes a case member having a terminal insertion hole, a terminal member inserted through the terminal insertion hole, and a resin member made of an insulating resin material and hermetically adhering to the case member and the terminal member to fix the terminal member to the case member while insulating the members from each other. The terminal member has an encircling band-shaped first roughened portion that has a roughened surface and surrounds the terminal member, and a second roughened portion that is spaced apart from the first roughened portion and has a roughened surface. The resin member is insert-molded integrally with the case member and the terminal member, and has an encircling band-shaped terminal seal portion that hermetically adheres to the first roughened portion, and a stress reducing portion that adheres to the second roughened portion and reduces stress generated in the terminal seal portion.

### CROSS-REFERENCE TO RELATED APPLICATIONS

This application is based upon and claims the benefit of priority from the prior Japanese Patent Application No. 2023-191761 filed on Nov. 9, 2023, the entire contents of which are incorporated herein by reference.

### BACKGROUND

### Technical Field

The disclosure relates to a power storage device.

### Related Art

A method is known in which a lid of a case member of a power storage device is provided with a terminal insertion hole, a terminal member is inserted through the terminal insertion hole, and the lid and the terminal member are integrally and hermetically fixed to each other with an insulating resin member by insert molding (see Japanese unexamined patent application publication No. 2016-44303 (JP 2016-44303 A)).

### SUMMARY

### Technical Problems

In the power storage device of the related art, however, stress due to a difference in thermal expansion may be generated as the temperature decreases in the process of insert molding, because of differences in the coefficient of thermal expansion between the case member (lid), terminal member, and the resin member, and cracking due to the stress may occur in the resin member along the terminal member and impair airtightness of the case, after molding or during cooling in a cold/heat thermal cycle test, for example. Thus, there are some cases where the reliability concerning airtightness is reduced.

The disclosure was made in view of the situation as described above, and provides a power storage device that has enhanced reliability concerning airtightness, even in the presence of an insulating resin member formed integrally with a case member and a terminal member by insert molding.

### Means of Solving the Problems

(1) One aspect of the disclosure for solving the above problem is a power storage device including a case member having a terminal insertion hole, a terminal member inserted through the terminal insertion hole, and a resin member comprising an insulating resin material and hermetically adhering to the case member and the terminal member to fix the terminal member to the case member while insulating the terminal member from the case member. In the power storage device, the terminal member has an encircling or annular or endless band-shaped first roughened portion that has a roughened surface and surrounds the terminal member, and a second roughened portion that is spaced apart from the first roughened portion and has a roughened surface. The resin member is insert-molded integrally with the case member and the terminal member inserted through the terminal insertion hole, and has an encircling or annular or endless band-shaped terminal seal portion that hermetically adheres to the first roughened portion of the terminal member, and a stress reducing portion that adheres to the second roughened portion of the terminal member and reduces stress generated in the terminal seal portion.

In the power storage device described above, stress remains in the resin member as the temperature decreases after insert molding. In the power storage device, however, the terminal seal portion of the resin member adheres to the first roughened portion of the terminal member to maintain airtightness between the first roughened portion and the terminal seal portion, and the stress reducing portion of the resin member adheres to the second roughened portion of the terminal member to reduce stress generated in the terminal seal portion of the resin member. Therefore, in the power storage device, the stress generated in the terminal seal portion can be reduced compared to the case where the terminal member is not provided with the second roughened portion or the case where the resin member is not provided with the stress reducing portion. Thus, the problem that cracking occurs in the terminal seal portion and the airtightness of the terminal seal portion is reduced can be curbed, and the power storage device having enhanced reliability concerning airtightness is provided.

Examples of the case where the resin member is not provided with the stress reducing portion include the case where the resin member is not provided with a portion corresponding to the stress reducing portion, irrespective of the presence of the second roughened portion in the terminal member. Examples of the case where the terminal member is not provided with the second roughened portion include the case where the resin member has a portion corresponding to the stress reducing portion, but the terminal member is not provided with a roughened surface corresponding to the second roughened portion, so that the portion of the resin member corresponding to the stress reducing portion cannot adhere to the portion of the terminal member corresponding to the second roughened portion.

Examples of the power storage device include secondary batteries, such as a lithium-ion secondary battery and a sodium-ion secondary battery, and capacitors, such as a lithium-ion capacitor.

A first metal that forms the case member and a second metal that forms the terminal member may be the same (e.g., both metals are aluminum) or different (e.g., aluminum and copper) from each other.

The stress reducing portion of the resin member, which adheres to the second roughened portion of the terminal member, may contain a crack due to cohesive failure along the second roughened portion while maintaining adherence to the second roughened portion, or may have no cracks.

The second roughened portion of the terminal member may be formed in a range to which the stress reducing portion of the resin member adheres so that the stress generated in the terminal seal portion of the resin member can be reduced, and may have an encircling or annular band shape surrounding the terminal member or may not have an encircling band shape. The stress reducing portion may have an encircling or annular band shape adhering to the second roughened portion or may not have an encircling band shape.

(2) In the power storage device described above in (1), the stress reducing portion may be a crack containing portion that adheres to the second roughened portion of the terminal member and contains a crack due to cohesive failure along the second roughened portion.

In the above power storage device, the stress reducing portion is the crack containing portion containing a crack. That is, it is considered that a crack due to cohesive failure formed in the stress reducing portion because the stress generated in the stress reducing portion exceeded the strength of the resin material. Nonetheless, the stress generated in the stress reducing portion is released due to formation of the crack, resulting in reduction of the stress generated in the terminal seal portion, and a further stable state can be established.

(3) In the power storage device described above in (1) or (2), nanocolumns formed by joining particles derived from the terminal member together like strings of beads into the form of columns and having a height of 50 nm or greater may stand numerously on the first roughened portion of the terminal member, and the terminal seal portion of the resin member may hermetically adhere to the first roughened portion such that gaps between the nanocolumns standing numerously are filled with the resin material.

In the above power storage device, the first roughened portion of the terminal member has a roughened surface on which the nanocolumns stand together in large numbers. On the other hand, the resin material that forms the terminal seal portion of the resin member fills gaps between the nanocolumns, so that the first roughened portion and the terminal seal portion can firmly adhere to each other, and the airtightness between these portions can be well maintained.

(4) In the power storage device described above in any one of (1) to (3), nanocolumns formed by joining particles derived from the terminal member together like strings of beads into the form of columns and having a height of 50 nm or greater may stand numerously on the second roughened portion of the terminal member, and the stress reducing portion of the resin member may hermetically adhere to the second roughened portion such that gaps between the nanocolumns standing numerously are filled with the resin material.

In the above power storage device, the second roughened portion of the terminal member has a roughened surface on which the nanocolumns stand together in large numbers. On the other hand, the resin material that forms the stress reducing portion of the resin member fills gaps between the nanocolumns, so that the second roughened portion and the stress reducing portion can firmly adhere to each other.

### BRIEF DESCRIPTION OF THE DRAWINGS

FIG. 1 is a perspective view of a battery according to one embodiment, a comparative example, and a modified embodiment;

FIG. 2 is a vertical cross-sectional view of the battery according to the embodiment, comparative example, and the modified embodiment, taken along the battery height direction and the battery width direction;

FIG. 3 is a partially enlarged cross-sectional view showing an enlarged view of a terminal insertion hole of a lid member and its vicinity of the battery according to the embodiment;

FIG. 4 is a partially enlarged cross-sectional view showing nanocolumns standing numerously on roughened portions of the terminal member and the lid member and a resin member filling gaps between the nanocolumns, in connection with the embodiment, comparative example, and the modified embodiment;

FIG. 5 is a flowchart of a method of manufacturing the battery according to the embodiment;

FIG. 6 is an exploded view of the battery according to the embodiment, comparative example, and the modified embodiment;

FIG. 7 is an explanatory view showing the manner of forming a plurality of bowl-shaped recesses and nanocolumns standing numerously on the bowl-shaped recesses through scanning with a pulsed laser beam in a seal portion forming step, in connection with the method of manufacturing the battery according to the embodiment;

FIG. 8 is a partially enlarged cross-sectional view of the battery of the modified embodiment, showing an enlarged view of a terminal insertion hole of a lid member and its vicinity, a terminal member, and a resin member;

FIG. 9 is a cross-sectional view of the battery of the modified embodiment as seen in the direction of arrows D-D in FIG. 8; and

FIG. 10 is a partially enlarged cross-sectional view of the battery of the comparative example, showing an enlarged view of a terminal insertion hole of a lid member and its vicinity, a terminal member, and a resin member.

### DETAILED DESCRIPTION OF THE EXEMPLARY EMBODIMENTS

### Embodiment

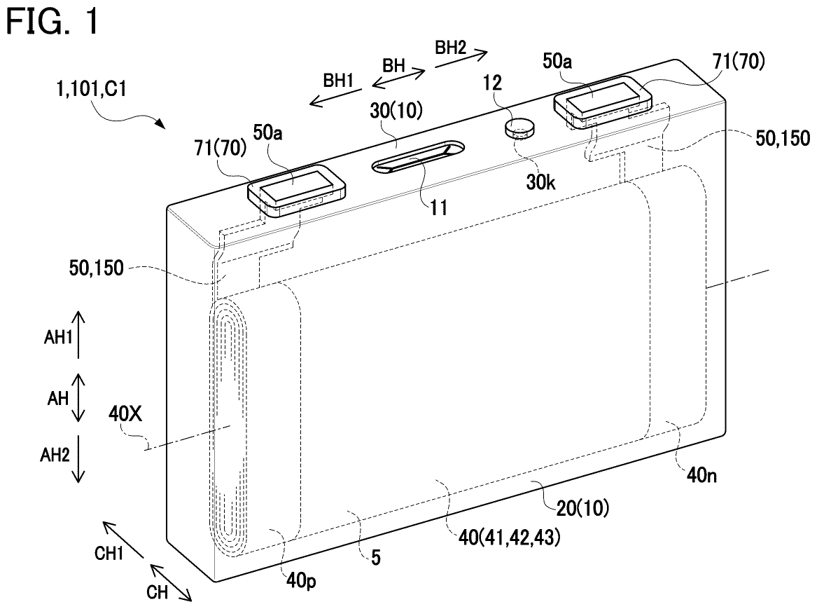

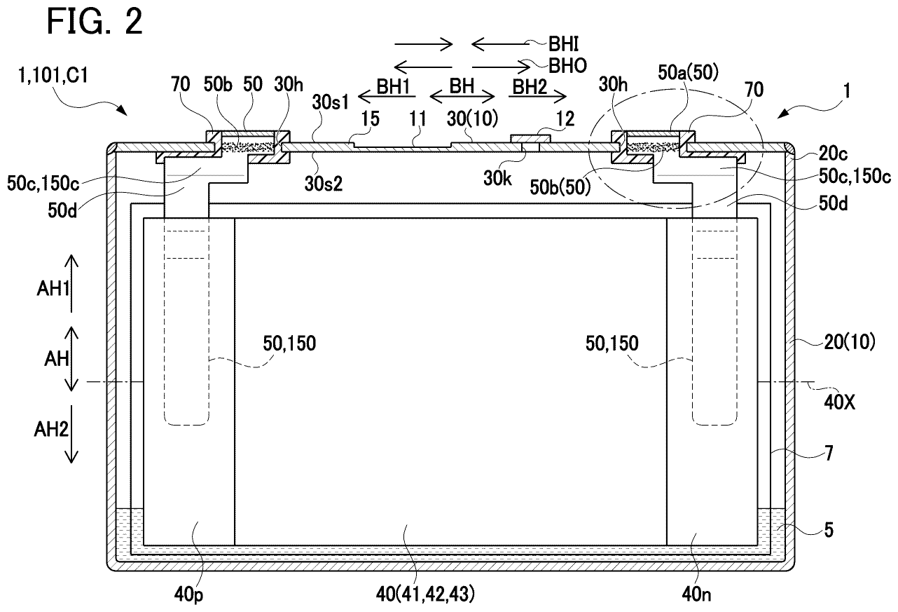

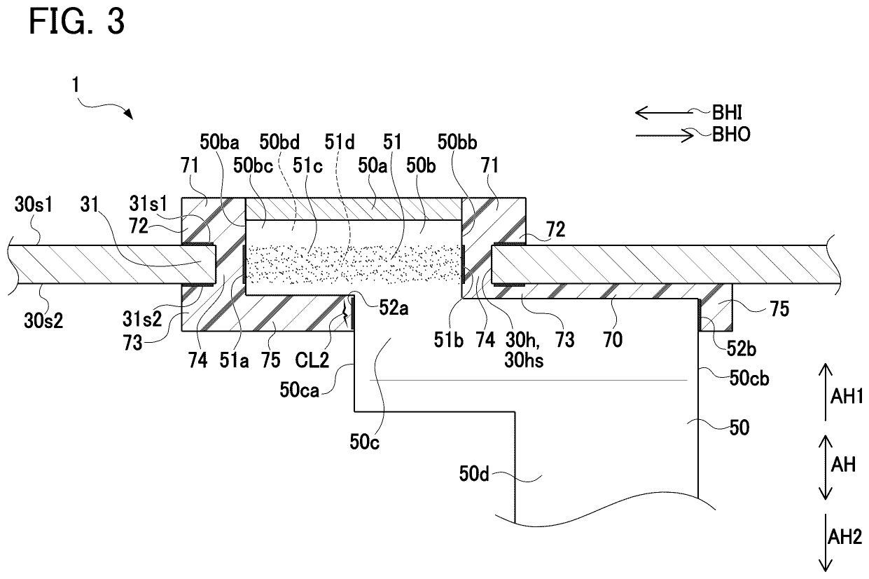

In the following, one embodiment of the disclosure will be described with reference to the drawings. FIG. 1 is a perspective view of a battery (one example of the power storage device of the disclosure) 1 according to the embodiment, and FIG. 2 is a vertical cross-sectional view of the battery 1. FIG. 3 is a partially enlarged cross-sectional view of a terminal insertion hole 30h of a lid member 30 and its vicinity, as a part of a lid assembly 15 of the battery 1. In the following description, the battery height direction AH, battery width direction BH, and battery thickness direction CH of the battery 1 are defined as the directions indicated in FIG. 1 and FIG. 2.

The battery 1 is a sealed lithium-ion secondary battery of a rectangular (rectangular parallelepiped) shape, which is installed on a vehicle, such as a hybrid vehicle, plug-in hybrid vehicle, or an electric vehicle. The battery 1 consists of a case 10, an electrode body 40 housed in the case 10, positive and negative terminal members 50 fixed to the case 10 via respective resin members 70, and so forth. In the case 10, the electrode body 40 is covered with a bag-like insulating holder 7 made from an insulating film. The case 10 also contains electrolyte 5, and the electrode body 40 is impregnated with a part of the electrolyte 5, while the rest of the electrolyte 5 is collected and kept on a bottom wall of the case 10.

The case 10 is shaped like a rectangular parallelepiped box and made of metal (aluminum in this embodiment). The case 10 consists of a case body 20 that is in the form of a rectangular tube with a bottom and a rectangular opening portion 20c and houses the electrode body 40 therein, and a lid member 30 in the form of a rectangular plate that closes the opening portion 20c of the case body 20. The opening portion 20c of the case body 20 and a peripheral portion 30f of the lid member 30 are hermetically welded together over the entire circumference thereof. The lid member 30 is provided with a safety valve 11 that breaks and opens when the internal pressure of the case 10 exceeds the valve opening pressure. The lid member 30 is also provided with a liquid inlet 30k, and the liquid inlet 30k is hermetically sealed with a disc-shaped plug 12 made of aluminum.

The electrode body 40 is of a winding type having a flat, cylindrical shape, and is formed by stacking and winding long strips of positive electrode sheet 41 and negative electrode sheet 42 alternately with two long strips of porous resin separators 43, and then compressing the roll in the battery thickness direction CH into a flat shape. On one side BH1 (the left side in FIG. 2) of the electrode body 40 in the battery width direction BH along the winding axis 40X, a positive current collector 40p is formed in which a current collecting foil of the positive electrode sheet 41 is wound and stacked together. The positive current collector 40p is welded and conductively connected to the terminal member 50 of the positive electrode. On the other side BH2 (the right side in FIG. 2) of the electrode body 40 in the battery width direction BH, a negative current collector 40n is formed in which a current collecting foil of the negative electrode sheet 42 is wound and stacked together. The negative current collector 40n is welded and conductively connected to the terminal member 50 of the negative electrode.

Rectangular terminal insertion holes 30h that extend through the lid member 30 are respectively provided in portions of the lid member 30 near its opposite ends on one side BH1 and the other side BH2 in the battery width direction BH. The terminal member 50 of the positive electrode made of aluminum is inserted through the terminal insertion hole 30h on the one side BH1, and the terminal member 50 is hermetically fixed to the lid member 30 while being insulated from the lid member 30 via the resin member 70 that adheres to these members. On the other hand, the terminal member 50 of the negative electrode made of copper is inserted through the terminal insertion hole 30h on the other side BH2, and the terminal member 50 is hermetically fixed to the lid member 30 while being insulated from the lid member 30 via the resin member 70 that adheres to these members.

As can be easily understood from FIG. 1 and FIG. 2, the terminal members 50 of the positive and negative electrodes are generally in the form of mirror images, and each of the terminal members 50 is formed by cutting and bending a metal plate (an aluminum plate for the positive electrode, a copper plate for the negative electrode) by press working.

The terminal member 50 has a top plate 50a in the form of a rectangular flat plate extending in the battery width direction BH and the battery thickness direction CH and located on the upper side AH1 of the lid member 30 in the battery height direction AH, and a bent extension 50b that is bent at a right angle from an edge of the top plate 50a on one side CH1 (the back side in FIG. 2 and FIG. 3) in the battery thickness direction CH and extends to the lower side AH2 in the battery height direction AH. The terminal member 50 further has a stepped extension 50c and a connecting portion 50d. The stepped extension 50c is displaced from the bent extension 50b stepwise by about half the width of the bent extension 50b to the outer side BHO in the battery width direction BH (one side BH1 for the terminal member 50 of the positive electrode, the other side BH2 for the terminal member 50 of the negative electrode) (see FIG. 2), and extends to the lower side AH2 in the battery height direction AH. The connecting portion 50d extends from the stepped extension 50c to the lower side AH2 in the battery height direction AH while bending to the other side CH2 (the front side in FIG. 2) in the battery thickness direction CH on the way, and further extends to the lower side AH2 in the battery height direction AH. The bent extension 50b, stepped extension 50c, and connecting portion 50d are all rectangular in cross section perpendicular to the battery height direction AH and long in the battery width direction BH.

The bent extension 50b of the terminal member 50 is inserted through the terminal insertion hole 30h of the lid member 30. The connecting portion 50d of the terminal member 50 of the positive electrode is welded to the positive current collector 40p of the electrode body 40, so that the positive potential of the positive current collector 40p is drawn to the top plate 50a of the terminal member 50 of the positive electrode. Similarly, the connecting portion 50d of the terminal member 50 of the negative electrode is welded to the negative current collector 40n of the electrode body 40, so that the negative potential of the negative current collector 40n is drawn to the top plate 50a of the terminal member 50 of the negative electrode.

The terminal members 50 of the positive and negative electrodes are integrally fixed to the lid member 30 via the resin members 70 formed by insert molding. The resin member 70 of this embodiment is made of a resin material 70R including a thermoplastic main resin (specifically, polyphenylene sulfide (PPS)), a thermoplastic elastomer, and a filler (specifically, a fibrous glass filler). The resin member 70 is generally divided into a top plate surrounding portion 71, a peripheral outer portion 72, a peripheral inner portion 73, an insertion hole filling portion 74 as a terminal seal portion, and a step surrounding portion 75 as a stress reducing portion. Of these portions, the top plate surrounding portion 71 is a rectangular encircling or annular portion or frame-like portion located on the outer side of the top plate 50a of the terminal member 50 in the plane direction, namely, located around the top plate 50a in the battery width direction BH and the battery thickness direction CH. The peripheral outer portion 72 is an encircling or annular portion located on the lower side AH2 of the top plate surrounding portion 71 and on the upper side AH1 of an encircling or annular peripheral portion 31 of the lid member 30 surrounding the terminal insertion hole 30h. The peripheral inner portion 73 is an encircling or annular portion located on the lower side AH2 of the peripheral portion 31 of the lid member 30. The insertion hole filling portion 74 is an encircling or annular portion located on the lower side AH2 of the top plate surrounding portion 71 and sandwiched between an inner circumferential surface 30hs of the terminal insertion hole 30h of the lid member 30 and the bent extension 50b of the terminal member 50. The step surrounding portion 75 is an encircling or annular portion that is located on the lower side AH2 of the insertion hole filling portion 74 and on the lower side AH2 of the lid member 30 and surrounds the stepped extension 50c of the terminal member 50.

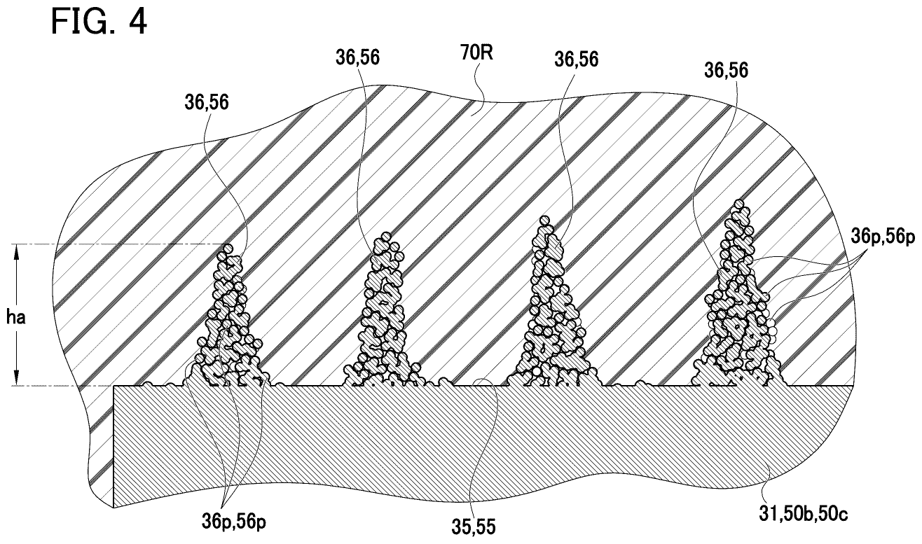

First, the joint and airtightness between the lid member 30 and the resin member 70 in the battery 1 will be described. On the outer surface 30s1 facing to the upper side AH1, of the encircling or annular peripheral portion 31 of the lid member 30 surrounding the terminal insertion hole 30h, an encircling or annular band-shaped lid seal outer roughened portion 31s1 surrounding the terminal insertion hole 30h is formed, as indicated by thick lines in FIG. 3. Also, on the inner surface 30s2 facing to the lower side AH2, of the peripheral portion 31, an encircling or annular band-shaped lid seal inner roughened portion 31s2 surrounding the terminal insertion hole 30h is formed, as indicated by thick lines in FIG. 3. The lid seal outer roughened portion 31s1 and the lid seal inner roughened portion 31s2 have roughened surfaces that are roughened by a roughening process using a pulsed laser beam LC which will be described below. Specifically, on the lid seal outer roughened portion 31s1 and the lid seal inner roughened portion 31s2, nanocolumns 36 formed by joining particles 36p derived from metal (aluminum in this embodiment) that forms the lid member 30 together like strings of beads into the form of columns and having a height ha of 50 nm or greater (the height ha is generally equal to 150 nm in this embodiment) stand together in large numbers, as shown in FIG. 4.

In addition, the lid seal outer roughened portion 31s1 and the lid seal inner roughened portion 31s2 are filled with the resin material 70R that forms the peripheral outer portion 72 and peripheral inner portion 73 of the resin member 70. Therefore, the lid seal outer roughened portion 31s1 and the peripheral outer portion 72, and the lid seal inner roughened portion 31s2 and the peripheral inner portion 73, are firmly fixed to each other over a long creepage distance in the width direction of the lid seal outer roughened portion 31s1 or the lid seal inner roughened portion 31s2 (a radial direction of the terminal insertion hole 30h). Thus, the resin member 70 firmly adheres to the peripheral portion 31 of the lid member 30, and the interface of the peripheral portion 31 of the lid member 30 and the resin member 70 is sealed with high airtightness by the encircling or annular lid seal outer roughened portion 31s1 and lid seal inner roughened portion 31s2. In the battery 1 of this embodiment, the peripheral portion 31 of the lid member 30 is provided with two roughened portions, that is, the lid seal outer roughened portion 31s1 and the lid seal inner roughened portion 31s2; therefore, the airtightness between the lid member 30 and the resin member 70 is ensured with particularly high reliability.

Next, the joint and airtightness between the terminal member 50 of the positive/negative electrode and the resin member 70 in the battery 1 will be described. The terminal member 50 of the positive/negative electrode has an encircling or annular or endless band-shaped portion of the bent extension 50b, named first roughened portion 51, which is located near the terminal insertion hole 30h and surrounds the terminal member 50, as indicated by a scattered-point pattern and thick lines in FIG. 3. The first roughened portion 51 generally has a rectangular encircling or annular or endless band-shaped roughened surface consisting of four surfaces, i.e., an inner end face roughened portion 51a facing to the inner side BHI in the battery width direction BH, an outer end face roughened portion 51b facing to the outer side BHO in the battery width direction BH, and flat roughened portions 51c, 51d facing to one side CH1 (the back side in FIG. 3) and the other side CH2 (the front side in FIG. 3) in the battery thickness direction CH. The roughened surface of the first roughened portion 51 is also roughened by a roughening process using a pulsed laser beam LC which will be described below. Specifically, on the first roughened portion 51, too, nanocolumns 56 formed by joining particles 56p derived from metal (aluminum for the terminal member of the positive electrode and copper for the terminal member of the negative electrode in this embodiment) that forms the terminal member 50 together like strings of beads into the form of columns and having a height ha of 50 nm or greater (the height ha is generally equal to 150 nm in this embodiment) stand together in large numbers, as shown in FIG. 4.

The first roughened portion 51 is also filled with the resin material 70R that forms the insertion hole filling portion 74 of the resin member 70, as described below, and the insertion hole filling portion 74 of the resin member 70 firmly adheres to the first roughened portion 51 over a long creepage distance in the width direction of the first roughened portion 51 (the battery height direction AH in FIG. 3), in the bent extension 50b of the terminal member 50.

Therefore, the interface of the bent extension 50b of the terminal member 50 and the insertion hole filling portion 74 of the resin member 70, and thus the interface of the terminal member 50 and the resin member 70, can keep particularly good airtightness between the encircling or annular band-shaped first roughened portion 51 and the insertion hole filling portion 74.

Further in this embodiment, end face roughened portions 52a, 52b as a second roughened portion are formed in part of the stepped extension 50c of the positive/negative terminal member 50. Specifically, on the upper side AH1 in the battery height direction AH of the stepped extension 50c, the end face roughened portion 52a facing to the inner side BHI in the battery width direction BH and the end face roughened portion 52b facing to the outer side BHO in the battery width direction BH are formed with roughened surfaces formed by a roughening process using a pulsed laser beam LC that will be described below, as indicated by thick lines in FIG. 3. Specifically, on the end face roughened portions 52a, 52b, too, nanocolumns 56 formed by joining particles 56p derived from metal (aluminum or copper in this embodiment) that forms the terminal member 50 together like strings of beads into the form of columns and having a height ha of 50 nm or greater (the height ha is generally equal to 150 nm in this embodiment) stand together in large numbers, as shown in FIG. 4.

The end face roughened portions 52a, 52b of the stepped extension 50c are also filled with the resin material 70R that forms the resin member 70, as described below. Thus, the step surrounding portion 75 of the resin member 70 surrounds the stepped extension 50c of the terminal member 50, and also firmly adheres to at least the two end face roughened portions 52a, 52b of the stepped extension 50c.

As will be described below, the resin material 70R is subjected to injection molding, so that the lid member 30 and the pair of terminal members 50 inserted through the terminal insertion holes 30h are integrally fixed with the resin members 70, to form the lid assembly 15. However, since there are differences in the coefficient of thermal expansion between metals (aluminum and copper in this embodiment) that form the lid member 30 and the terminal members 50, and the resin material 70R, thermal stress due to the differences in thermal expansion is generated in each member of which the temperature decreased after molding.

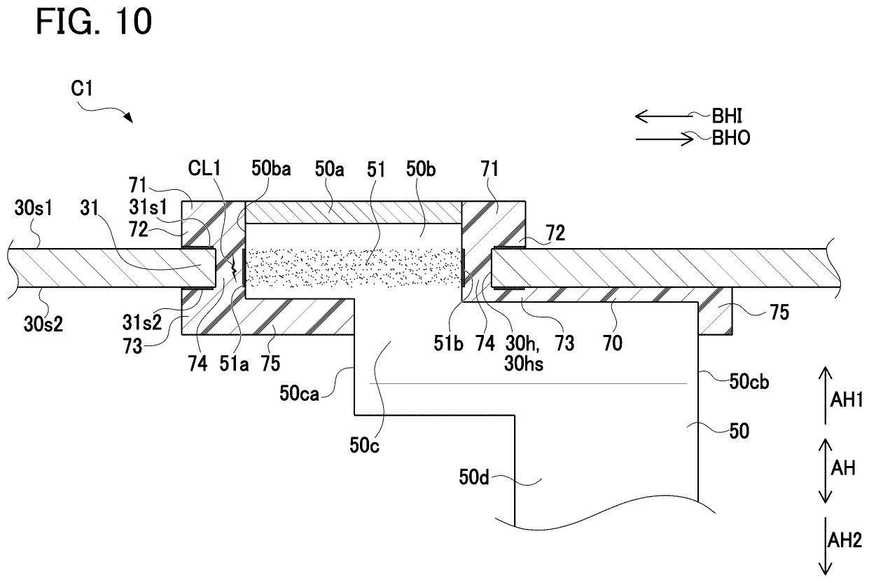

Here, stress generated in each portion of the resin member 70, etc., will be described by comparing the battery 1 of this embodiment with a battery C1 of a comparative example that is substantially the same as the battery 1 of this embodiment but differs from the battery 1 only in that the stepped extension 50c of the terminal member 50 is not provided with the end face roughened portions 52a, 52b, as shown in FIG. 10.

When the battery C1 of the comparative example is exposed to a temperature environment of about room temperature or exposed to an environment of a lower temperature (e.g., −40° C.) than room temperature in a cold/heat cycle test, for example, relatively high stress is generated in a portion of the insertion hole filling portion 74 of the resin member 70 near the first roughened portion 51. In particular, high stress is generated in a portion of the insertion hole filling portion 74 near the outer end face roughened portion 51b of the first roughened portion 51. In addition, even higher stress than that generated near the outer end face roughened portion 51b, i.e., the highest stress in the resin member 70, is generated in a portion of the insertion hole filling portion 74 near the inner end face roughened portion 51a.

Therefore, when the battery C1 is exposed to an environment of about room temperature or lower temperature, a crack CL1 due to cohesive failure may form along the inner end face roughened portion 51a in the portion of the insertion hole filling portion 74 of the resin member 70 near the inner end face roughened portion 51a. In addition, a crack (not shown) due to cohesive failure may also form in the vicinity of the outer end face roughened portion 51b. This may be because the stresses generated in these portions exceed the strength of the resin material 70R. In the battery C1 in which the crack CL1 forms in the insertion hole filling portion 74 of the resin member 70, the airtightness is significantly reduced at the interface of the terminal member 50 and the resin member 70. It is thus found that the battery C1 of the comparative example has low reliability concerning airtightness regardless of whether or not the crack CL1 is generated.

On the other hand, when the battery 1 of this embodiment is exposed to an environment of about room temperature or lower temperature, stresses generated in portions of the insertion hole filling portion 74 of the resin member 70 near the outer end face roughened portion 51b and inner end face roughened portion 51a of the first roughened portion 51 are reduced by a large degree (for example, to about ½ or less in this embodiment) compared to the battery C1.

Instead, higher stress than the stress around the outer end face roughened portion 51b of the first roughened portion 51 is generated in a portion of the step surrounding portion 75 of the resin member 70 near the end face roughened portion 52b on the outer side BHO. In addition, higher stress than the stress generated around the inner end face roughened portion 51a of the first roughened portion 51, which is the highest stress in the resin member 70, is generated around the end face roughened portion 52a on the inner side BHI.

In the battery 1 of this embodiment, the terminal member 50 is provided not only with the first roughened portion 51 adhering to the insertion hole filling portion 74, but also with the end face roughened portions 52a, 52b located on the outer side (the lower side AH2 in this embodiment) as seen from the insertion hole filling portion 74 and adhering to the step surrounding portion 75 having a relatively large volume, as described above. Therefore, most of the stresses generated in the resin member 70 due to the differences in thermal expansion caused by cooling of the battery 1 is applied to portions of the step surrounding portion 75 near the end face roughened portions 52a, 52b. Accordingly, it is considered that the stresses generated in portions of the insertion hole filling portion 74 near the outer end face roughened portion 51b and inner end face roughened portion 51a of the first roughened portion 51 are reduced compared to the battery C1.

Namely, in this embodiment, parts of the step surrounding portion 75 of the resin member 70 adhere to the end face roughened portions 52a, 52b of the terminal member 50, so that the stresses generated in the insertion hole filling portion 74, in particular, the stresses generated around the outer end face roughened portion 51b and inner end face roughened portion 51a, are reduced.

As a result, in the battery 1 of this embodiment, unlike the battery C1, a crack CL1 (see FIG. 10) is prevented from forming in a portion or portions of the insertion hole filling portion 74 of the resin member 70 near the inner end face roughened portion 51a or near the inner end face roughened portion 51a and the outer end face roughened portion 51b.

Thus, in the battery 1, the maximum stress generated in the insertion hole filling portion 74 can be reduced compared to the case where the step surrounding portion 75 as the stress reducing portion is not provided in the resin member 70 or the case where the end face roughened portions 52a, 52b are not provided in the terminal member 50. Therefore, the problem that cracking occurs in the insertion hole filling portion 74 and the airtightness at the interface of the terminal member 50 and the resin member 70 is reduced, as in the battery C1 of the comparative example, can be curbed, and the battery 1 having high reliability concerning airtightness is provided.

In this connection, as shown in FIG. 3, a crack CL2 due to cohesive failure may form along the end face roughened portion 52a, in a portion of the step surrounding portion 75 near the end face roughened portion 52a in which the highest stress in the resin member 70 is generated. In addition, a crack (not shown) due to cohesive failure may also form along the end face roughened portion 52b in the vicinity of the end face roughened portion 52b on the outer side. This may be because the stresses generated in these portions exceed the strength of the resin material 70R. However, unlike the crack CL1 described above, the crack CL2 does not affect sealing by the insertion hole filling portion 74, and does not reduce the airtightness at the interface between the terminal member 50 and the resin member 70.

In the step surrounding portion 75 as a crack containing portion that contains the crack CL2, the stress generated in the step surrounding portion 75 before cracking is released due to formation of the crack CL2, and consequently, the stress generated in the insertion hole filling portion 74 is also reduced, resulting in a further stable state.

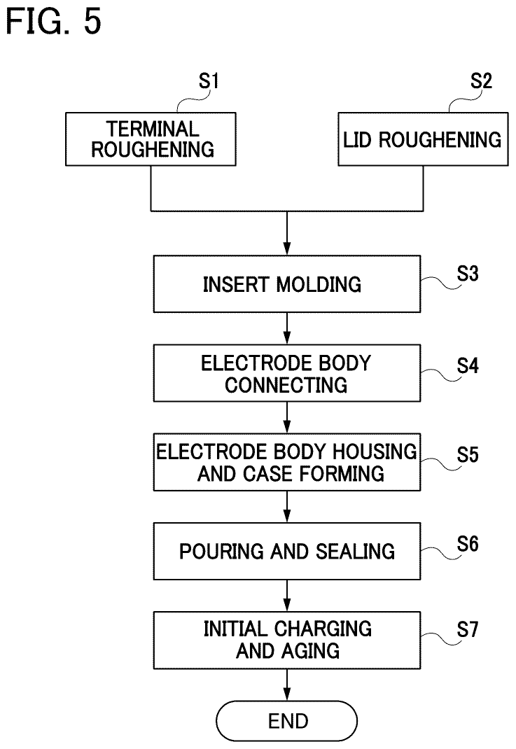

Next, a method of manufacturing the battery 1 of this embodiment will be described (see FIG. 5 to FIG. 8). First, the lid member 30 before roughening is prepared. The lid member 30 before roughening is obtained by press working using an aluminum plate. The terminal members 50 before roughening are also prepared. The terminal members 50 before roughening are obtained by press working using metal plates (an aluminum plate for the positive electrode and a copper plate for the negative electrode).

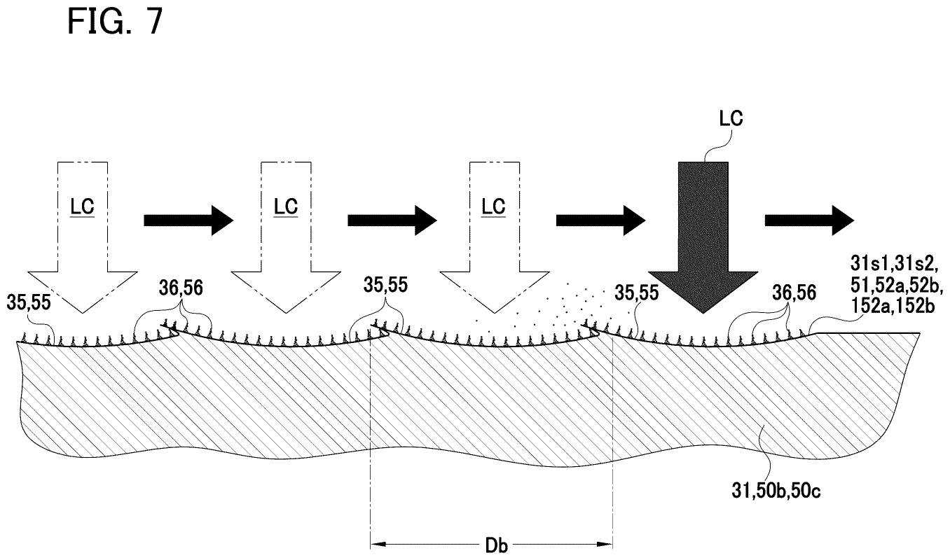

Then, in a terminal roughening step S1, a pulsed laser beam LC is intermittently applied to the bent extension 50b of each of the terminal members 50 described above while shifting the irradiation position, to form the encircling or annular band-shaped first roughened portion 51 in which numerous bowl-shaped recesses 55 are arranged while partially overlapping (see FIG. 3 and FIG. 7). Similarly, a pulsed laser beam LC is intermittently applied to portions on the upper side AH1 of the inner end face 50ca and outer end face 50cb of the stepped extension 50c of the terminal member 50 while shifting the irradiation position, to form the end face roughened portions 52a, 52b in which numerous bowl-shaped recesses 55 are arranged while partially overlapping (see FIG. 3 and FIG. 7).

Meanwhile, in a lid roughening step S2, a pulsed laser beam LC is intermittently applied to the outer surface 30s1 and inner surface 30s2, respectively, of the peripheral portion 31 of the terminal insertion hole 30h of the lid member 30 while shifting the irradiation position, to respectively form the encircling or annular band-shaped lid seal outer roughened portion 31s1 and lid seal inner roughened portion 31s2 in each of which numerous bowl-shaped recesses 35 are arranged while partially overlapping (see FIG. 3 and FIG. 7). The irradiation conditions of the pulsed laser beam LC are substantially the same as those under which the laser beam is applied to the terminal member 50 of the positive electrode in the terminal roughening step S1.

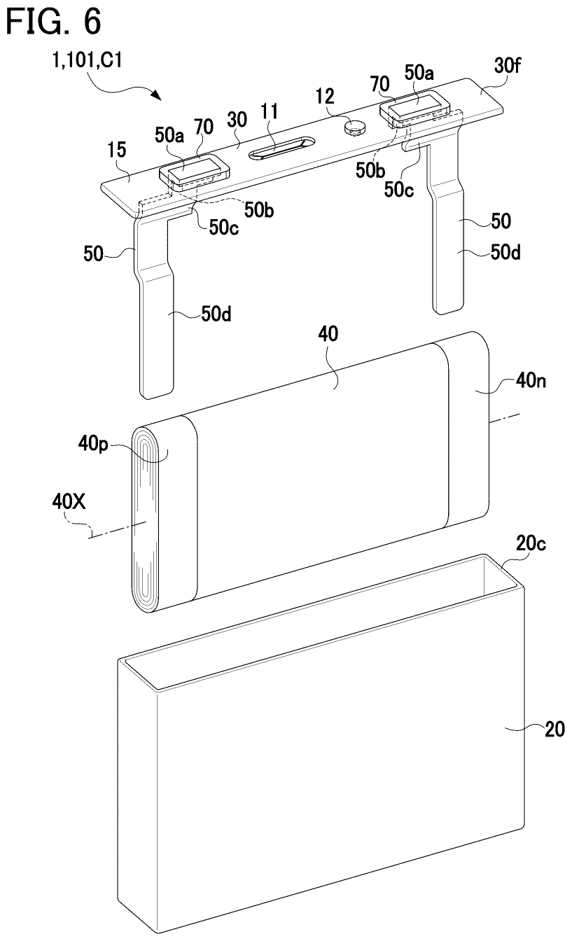

Then, in an insert molding step S3, the lid assembly 15 in which the lid member 30 and the pair of terminal members 50 are integrally fixed with the resin member 70 is formed (see the upper section in FIG. 6). More specifically, the positive and negative terminal members 50 are respectively inserted through the pair of terminal insertion holes 30h of the lid member 30 in molds (not shown), and the molten resin material 70R is injected into the molds to adhere to the peripheral portions 31 of the lid member 30 and parts of the top plates 50a, bent extensions 50b, and stepped extensions 50c of the terminal members 50, and cooled, so that the pair of resin members 70 are insert-molded. At this time, the molten resin material 70R fills gaps between the nanocolumns 36 standing numerously on the lid seal outer roughened portions 31s1 and lid seal inner roughened portions 31s2 of the lid member 30 and gaps between the nanocolumns 56 standing numerously on the first roughened portions 51 and end face roughened portions 52a, 52b of the terminal members 50, to firmly adhere to the lid member 30 and the terminal members 50.

Next, in an electrode body connecting step S4, the connecting portion 50d of the terminal member 50 of the positive electrode, as part of the lid assembly 15 described above, is welded to the positive current collector 40p of the electrode body 40 prepared in advance (see FIG. 1, FIG. 2, and FIG. 6). Also, the connecting portion 50d of the terminal member 50 of the negative electrode, as part of the lid assembly 15, is welded to the negative current collector 40n of the electrode body 40. The electrode body 40 is then wrapped with the bag-like insulating holder 7.

Next, in an electrode body housing and case forming step S5, the electrode body 40 covered with the insulating holder 7 is inserted into the case body 20, and the opening portion 20c of the case body 20 is closed with the lid member 30. Then, the opening portion 20c of the case body 20 and the peripheral portion 30f of the lid member 30 are laser welded hermetically over the entire periphery to form the case 10 with the electrode body 40 housed inside.

Next, in a pouring and sealing step S6, the electrolyte 5 is poured into the case 10 through the liquid inlet 30k, so that the electrode body 40 is impregnated with the electrolyte 5. The liquid inlet 30k is then covered from the outside with the plug 12, and the plug 12 is laser welded hermetically to the case 10.

Next, in an initial charging and aging step S7, a charging device (not shown) is connected to the battery 1 to perform initial charging on the battery 1. Then, the initially charged battery 1 is left to stand at a high temperature (e.g., 60° C.) for a predetermined time so that the battery 1 is aged. In this manner, the battery 1 is completed.

Substantially the same process for producing the battery 1 is used for production of the battery C1 of the comparative example. In the terminal roughening step S1, however, the end face roughened portions 52a, 52b are not formed on the inner end face 50ca and outer end face 50cb of the stepped extension 50c of the terminal member 50, and only the encircling or annular band-shaped first roughened portion 51 is formed in the bent extension 50b (see FIG. 10).

### Modified Embodiment

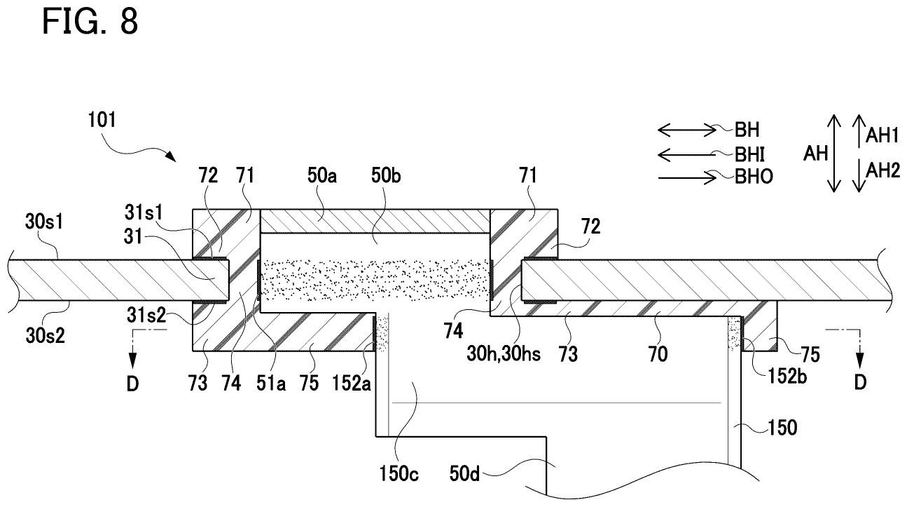

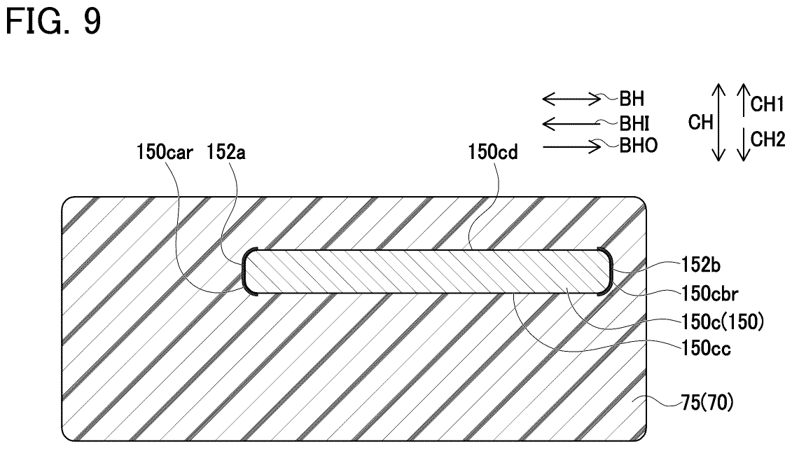

Next, a battery 101 according to a modified embodiment will be described with reference to the drawings. The battery 101 of the modified embodiment is different from the battery 1 of the above embodiment in the cross-sectional shape of a stepped extension 150c of a terminal member 150 and the form of roughened portions provided in the stepped extension 150c (see FIG. 8 and FIG. 9), but is otherwise similar to the battery 1. Thus, the different portions will be mainly described, and the same reference numerals are assigned to the same portions or components, of which description will be omitted or simplified.

The terminal member 150 used in the battery 101 has substantially the same shape as the terminal member 50 of the battery 1. As described above, the transverse section of the stepped extension 50c of the terminal member 50 is rectangular in shape, and the end face roughened portions 52a, 52b are respectively formed on portions on the upper side AH1 of the inner end face 50ca facing to the inner side BHI and the outer end face 50cb facing to the outer side BHO.

On the other hand, the transverse section of the stepped extension 150c of the terminal member 150 is rectangular with rounded corners, as shown in FIG. 9. Specifically, the stepped extension 150c has an inner end R surface 150car facing to the inner side BHI and an outer end R surface 150cbr facing to the outer side BHO, with the corners R-chamfered to be integrated with the end faces, in addition to flat surfaces 150cc, 150cd extending in the battery width direction BH. Then, end R surface roughened portions 152a, 152b as second roughened portions are respectively formed on portions on the upper side AH1 of the inner end R surface 150car and outer end R surface 150cbr of the stepped extension 150c. Like the end face roughened portions 52a, 52b of the battery 1, nanocolumns 56 formed by joining particles 56p derived from metal (aluminum or copper in this embodiment) that forms the terminal member 150 together like strings of beads into the form of columns and having a height ha of 50 nm or greater (the height ha is generally equal to 150 nm in this embodiment) stand together in large numbers on the end R surface roughened portions 152a, 152b of the battery 101, as shown in FIG. 4.

The end R surface roughened portions 152a, 152b of the stepped extension 150c are also filled with the resin material 70R that forms the resin member 70. Therefore, the step surrounding portion 75 of the resin member 70 surrounds the stepped extension 150c of the terminal member 150, and firmly adheres to at least the two end R surface roughened portions 152a, 152b of the stepped extension 150c.

Thus, as is the case with the battery 1 of the embodiment, when the battery 101 of the modified embodiment is exposed to an environment of about room temperature or lower temperature, stresses generated in portions of the insertion hole filling portion 74 of the resin member 70 near the outer end face roughened portion 51b and inner end face roughened portion 51a of the first roughened portion 51 are reduced by a large degree (e.g., to about 1/2 or less in the modified embodiment) compared to the battery C1.

Meanwhile, higher stress than the stress generated in the vicinity of the outer end face roughened portion 51b of the first roughened portion 51 is generated in a portion of the resin member 70 near the outer end R surface roughened portion 152b of the step surrounding portion 75. In addition, higher stress than the stress generated in the vicinity of the inner end face roughened portion 51a of the first roughened portion 51, which is the highest stress in the resin member 70, is generated in the vicinity of the inner end R surface roughened portion 152a.

Accordingly, the maximum stress generated in the insertion hole filling portion 74 can be reduced compared to the case where the resin member 70 is not provided with the step surrounding portion 75 and the case where the terminal member 150 is not provided with the end R surface roughened portions 152a, 152b. Thus, the problem that cracking occurs in the insertion hole filling portion 74 and the airtightness at the interface of the terminal member 50 and the resin member 70 is reduced can be curbed, and the battery 101 having high reliability concerning airtightness is provided.

Comparing the battery 1 of the embodiment and the battery 101 of the modified embodiment, the stress generated in portions of the step surrounding portion 75 near the end R surface roughened portions 152a, 152b in the battery 101 is relatively lower than the stress generated in portions of the step surrounding portion 75 near the end face roughened portions 52a, 52b in the battery 1. The reason is considered as follows. As described above, in the battery 1, the transverse section of the stepped extension 50c of the terminal member 50 is rectangular in shape; therefore, stress is likely to be concentrated near the corners and high stress is easily generated. On the other hand, in the battery 101 of the modified embodiment, the transverse section of the stepped extension 150c of the terminal member 150 is rectangular with rounded corners as described above. Thus, it may be considered that the stress concentration does not occur around the corners, and the stress generated in the step surrounding portion 75 near the end R surface roughened portions 152a, 152b is relatively low.

As described above, in the battery 1, a crack CL2 due to cohesive failure may form in the step surrounding portion 75 along the end face roughened portion 52a, as shown in FIG. 3. In addition, cracking may occur along the outer end face roughened portion 52b. In contrast, in the battery 101, cracking is less likely or unlikely to occur in the step surrounding portion 75 compared to the battery 1, as is understood from FIG. 8 in which no crack CL2 is depicted. This may be because the stress generated in the step surrounding portion 75 is relative low, and is less likely or unlikely to exceed the strength of the resin material 70R, as described above. Therefore, the battery 101 is less likely to provide a mixture of batteries in which stress was released due to formation of the crack CL2 and batteries in which stress has not been released, and the battery 101 with stable quality can be obtained.

While the disclosure has been described in the light of the embodiment and the modified embodiment, it is to be understood that the disclosure is not limited to the embodiments, but may be applied by making changes as needed, without departing from the principle of the disclosure.

In the embodiment, the end face roughened portions 52a, 52b are provided on the inner end face 50ca and outer end face 50cb, respectively, of the stepped extension 50c of the terminal member 50, but no roughened portions are provided on the flat surfaces 50cc, 50cd facing in the battery thickness direction CH.

However, like the first roughened portion 51, the stepped extension 50c may also be provided with an encircling or annular band-shaped second roughened portion including the end face roughened portions 52a, 52b and surrounding the stepped extension 50c.

In the embodiment, the lid seal outer roughened portion 31s1, the first roughened portion 51, the end face roughened portions 52a, 52b, etc. are formed with the roughened surfaces on which the nanocolumns 36, 56 stand numerously through irradiation with the pulsed laser beam LC. However, other roughening treatments, for example, physical roughening treatments, such as shot blasting, polishing, and thermal spraying, and chemical roughening treatments, such as anodic oxidation, may also be used to form the roughened surfaces.

### REFERENCE SIGNS LIST

1, 101, C1 Battery (Power storage device)
10 Case
20 Case body (Case member)
30 Lid member (Case member)
30h Terminal insertion hole
30hs Inner circumferential surface (of terminal insertion hole)
31 Peripheral portion
31s1 Lid seal outer roughened portion (of lid member)
31s2 Lid seal inner roughened portion (of lid member)
40 Electrode body
50, 150 Terminal member
50a Top plate
50b Bent extension
50c, 150c Stepped extension
50ca Inner end face
50cb Outer end face
150car Inner end R surface
150cbr Outer end R surface
50d Connecting portion
51 First roughened portion
51a Inner end face roughened portion
51b Outer end face roughened portion
51c, 51d Flat roughened portion
52a, 52b End face roughened portion (Second roughened portion)
152a, 152b End R surface roughened portion (Second roughened portion)
70, 170 Resin member
70R Resin material
71 Top plate surrounding portion
72 Peripheral outer portion
73 Peripheral inner portion
74 Insertion hole filling portion (Terminal seal portion)
75 Step surrounding portion (Stress reducing portion, Crack containing portion)
175 Step surrounding portion (Stress reducing portion)
CL1, CL2 Crack
LC Pulsed laser beam

What is claimed is:

1. A power storage device comprising:
a case member having a terminal insertion hole;
a terminal member inserted through the terminal insertion hole; and
a resin member comprising an insulating resin material and hermetically adhering to the case member and the terminal member to fix the terminal member to the case member while insulating the terminal member from the case member,
wherein the terminal member has an encircling band-shaped first roughened portion that has a roughened surface and surrounds the terminal member, and a second roughened portion that is spaced apart from the first roughened portion and has a roughened surface, and
wherein the resin member is insert-molded integrally with the case member and the terminal member inserted through the terminal insertion hole, and has an encircling band-shaped terminal seal portion that hermetically adheres to the first roughened portion of the terminal member, and a stress reducing portion that adheres to the second roughened portion of the terminal member and reduces stress generated in the terminal seal portion.

2. The power storage device according to claim 1, wherein the stress reducing portion comprises a crack containing portion that adheres to the second roughened portion of the terminal member and contains a crack due to cohesive failure along the second roughened portion.

3. The power storage device according to claim 1, wherein:
nanocolumns formed by joining particles derived from the terminal member together like strings of beads into the form of columns and having a height of 50 nm or greater stand numerously on the first roughened portion of the terminal member; and
the terminal seal portion of the resin member hermetically adheres to the first roughened portion such that gaps between the nanocolumns standing numerously are filled with the resin material.

4. The power storage device according to claim 1, wherein:
nanocolumns formed by joining particles derived from the terminal member together like strings of beads into the form of columns and having a height of 50 nm or greater stand numerously on the second roughened portion of the terminal member; and
the stress reducing portion of the resin member hermetically adheres to the second roughened portion such that gaps between the nanocolumns standing numerously are filled with the resin material.

5. The power storage device according to claim 2, wherein nanocolumns formed by joining particles derived from the terminal member together like strings of beads into the form of columns and having a height of 50 nm or greater stand numerously on the first roughened portion of the terminal member; and
the terminal seal portion of the resin member hermetically adheres to the first roughened portion such that gaps between the nanocolumns standing numerously are filled with the resin material.

6. The power storage device according to claim 2 wherein: nanocolumns formed by joining particles derived from the terminal member together like strings of beads into the form of columns and having a height of 50 nm or greater stand numerously on the second roughened portion of the terminal member; and
the stress reducing portion of the resin member hermetically adheres to the second roughened portion such that gaps between the nanocolumns standing numerously are filled with the resin material.

7. The power storage device according to claim 3 wherein: nanocolumns formed by joining particles derived from the terminal member together like strings of beads into the form of columns and having a height of 50 nm or greater stand numerously on the second roughened portion of the terminal member; and
the stress reducing portion of the resin member hermetically adheres to the second roughened portion such that gaps between the nanocolumns standing numerously are filled with the resin material.

8. The power storage device according to claim 5 wherein: nanocolumns formed by joining particles derived from the terminal member together like strings of beads into the form of columns and having a height of 50 nm or greater stand numerously on the second roughened portion of the terminal member; and
the stress reducing portion of the resin member hermetically adheres to the second roughened portion such that gaps between the nanocolumns standing numerously are filled with the resin material.
